(19) United States
(12) Patent Application Publication
(10) Pub. No.: US 2025/0095903 A1
(43) Pub. Date: Mar. 20, 2025

(54) COIL DEVICE AND PULSE TRANSFORMER

(71) Applicants: Jiaxiong HE, Taoyuan City (CN); Zhengzhe CHEN, Taoyuan City (CN); JIANGXI GUDIAN ELECTRONICS CO., LTD, Ji'an City (CN)

(72) Inventor: Jiaxiong HE, Taoyuan City (CN)

(21) Appl. No.: 18/886,450

(22) Filed: Sep. 16, 2024

(30) Foreign Application Priority Data
Sep. 18, 2023 (CN) 202311202182.6

(51) Int. Cl. H01F 27/28; H01F 27/24

(52) U.S. Cl. CPC H01F 27/28; H01F 27/24

(57) ABSTRACT

A coil device and a pulse transformer are provided. The coil device includes a core part and multiple coils. The core part includes one winding part and two mounting parts. The two mounting parts are respectively located at both ends of the winding part. Each coil is wound on the periphery of the winding part. An upper end of the mounting part is provided with multiple convex parts arranged at intervals. Each convex part is provided with an electroplated layer. Ends of the coil are connected with different electroplated layers. One side, connected to the winding part, of the mounting part is an inner edge surface. One side, opposite to the inner edge surface, of the mounting part is an outer edge surface. There are no gaps between the electroplated layer and the inner edge surface and between the electroplated layer and the outer edge surface.

### CROSS-REFERENCE TO RELATED APPLICATION

This patent application claims the benefit and priority of Chinese Patent Application No. 202311202182.6 filed with the China National Intellectual Property Administration on Sep. 18, 2023, the disclosure of which is incorporated by reference herein in its entirety as part of the present application.

### TECHNICAL FIELD

The present disclosure relates to the technical field of passive electronic components, in particular to a coil device and a pulse transformer.

### BACKGROUND

The pulse transformer is a passive electronic component, and is often used in electronic products. The pulse transformer can resist current changes in electronic circuits, thus having the functions of filtering current noise, stabilizing current value in circuits, reducing electromagnetic interference (EMI), converting power and so on.

The components of the pulse transformer include a coil device mainly including an iron core, a plurality of electroplated layers and a plurality of coils. Generally, the iron core of the coil device includes a winding part and mounting parts arranged on both opposite sides of the winding part. Each coil is wound on the winding part, and the end points of each coil are connected to the electroplated layers arranged on the mounting part. In the prior art, due to the installation position and installation mode of each electroplated layer of the coil device, the pulse transformer welded to the circuit board may fall off due to unstable connection.

### SUMMARY

The present disclosure aims to provide a coil device and a pulse transformer to solve the problems in the prior art, so that the pulse transformer welded to the circuit board is avoided from falling off, and the qualified rate of products is improved.

In order to achieve the purpose, the present disclosure provides the following scheme.

The present disclosure provides a coil device. The coil device includes a core part and a plurality of coils. The core part includes one winding part and two mounting parts, the two mounting parts are respectively located on both ends of the winding part, each of the coils is wound on a periphery of the winding part, an upper end of each of the two mounting part is provided with a plurality of convex parts arranged at intervals, each of the convex parts is provided with an electroplated layer, ends of each of the coils are connected with different electroplated layers, one side, connected to the winding part, of each of the two mounting parts is an inner edge surface, one side, opposite to the inner edge surface, of the each of the two mounting part is an outer edge surface, and there are no gaps between the electroplated layer and the inner edge surface and between the electroplated layer and the outer edge surface.

Optionally, the convex parts on one of the two mounting parts include a first convex part, a second convex part and a third convex part which are arranged in sequence, and the convex parts on an other of the two mounting parts include a fourth convex part, a fifth convex part and a sixth convex part which are arranged in sequence, and one side of the electroplated layer on each of the first convex part, the second convex part, the third convex part, the fourth convex part, the fifth convex part and the sixth convex part is connected with an upper end of the inner edge surface.

Optionally, an other side of the electroplated layer on each of the third convex part and the sixth convex part is connected with an upper end of the outer edge surface, an other side of the electroplated layer on each of the second convex part and the fifth convex part extends to a surface of the outer edge surface, and an other side of the electroplated layer on each of the first convex part and the fourth convex part extends to a side wall surface perpendicular to the inner edge surface and the outer edge surface.

Optionally, the second convex part and the fifth convex part are both L-shaped, the first convex part, the third convex part, the fourth convex part and the sixth convex part are all rectangular, the first convex part is located at a notch of the second convex part, and the fourth convex part is located at a notch of the fifth convex part.

Optionally, an other side of the electroplated layer on each of the first convex part, the second convex part, the third convex part, the fourth convex part, the fifth convex part and the sixth convex part extends to a surface of the outer edge surface.

Optionally, the plurality of coils include four coils including a first coil, a second coil, a third coil and a fourth coil, a starting end of the first coil is located on the electroplated layer on the first convex part, and a tail end of the first coil is located on the electroplated layer on the sixth convex part; a starting end of the second coil is located on the electroplated layer on the third convex part, and a tail end of the second coil is located on the electroplated layer on the fifth convex part; a starting end of the third coil is located on the electroplated layer on the sixth convex part, and a tail end of the third coil is located on the electroplated layer on the second convex part; a starting end of the fourth coil is located on the electroplated layer on the fourth convex part, and a tail end of the fourth coil is located on the electroplated layer on the third convex part.

Preferably, the convex parts, the two mounting parts and the winding part are made of same materials and integrally molded.

The present disclosure also provides a pulse transformer. The pulse transformer includes a magnetic cover, an adhesive layer and the coil device in the technical scheme. The coil device is mounted on the magnetic cover via the adhesive layer.

Optionally, the magnetic cover includes a base plate and two side plates, the two side plates are symmetrically mounted on both sides of the base plate, and a connecting line between the two side plates is perpendicular to a connecting line between the two mounting parts.

Optionally, an upper end of each of the two side plates is flush with an upper end of each of the two mounting parts, or a height of an upper end of each of the two side plates is equal to half of a height of an upper end of each of the two mounting parts.

Compared with the prior art, the present disclosure has the following technical effects.

According to the coil device provided by the present disclosure, the coil device includes a core part and a plurality of coils. The core part includes one winding part and two mounting parts. The two mounting parts are respectively located on both ends of the winding part. Each coil is wound on the periphery of the winding part. An upper end of each mounting part is provided with a plurality of convex parts arranged at intervals. Each convex part is provided with an electroplated layer. Ends of each coil are connected with different electroplated layers. One side, connected to the winding part, of each mounting part is an inner edge surface, and one side, opposite to the inner edge surface, of the each mounting part is an outer edge surface. There are no gaps between the electroplated layer and the inner edge surface and between the electroplated layer and the outer edge surface, and then both sides of the electroplated layer are non-uniform in weight distribution to cause part missing, so that the qualified rate of products is improved.

### BRIEF DESCRIPTION OF THE DRAWINGS

To more clearly illustrate the present embodiment of the present disclosure or the technical scheme in the prior art, the following briefly introduces the accompanying drawings to be used in the present embodiment. Apparently, the accompanying drawings in the following description show merely some embodiments of the present disclosure, and those skilled in the art may still derive other drawings from these accompanying drawings without creative efforts.

FIG. 1 is a structural schematic diagram of a coil device provided by the first embodiment.

FIG. 2 is an explosive view of the coil device in FIG. 1.

FIG. 3 is a top view of the coil device in FIG. 1.

FIG. 4 is a principle diagram of a circuit of a coil device provided by the first embodiment or the second embodiment.

FIG. 5 is a structural schematic diagram of a pulse transformer provided by the third embodiment.

FIG. 6 is a structural schematic diagram of a pulse transformer provided by the fourth embodiment.

FIG. 7 is a structural schematic diagram of a pulse transformer provided by the fifth embodiment.

FIG. 8 is a structural schematic diagram of a coil device provided by the second embodiment.

FIG. 9 is an explosive view of the coil device in FIG. 8.

FIG. 10 is a top view of the coil device in FIG. 8.

FIG. 11 is a structural schematic diagram of a pulse transformer provided by the sixth embodiment.

FIG. 12 is a structural schematic diagram of a pulse transformer provided by the seventh embodiment.

FIG. 13 is a structural schematic diagram of a pulse transformer provided by the eighth embodiment.

Reference numerals: 10 coil device; 11 winding part; 12 mounting part; 121 inner edge surface; 122 outer edge surface; 13 first convex part; 14 second convex part; 15 third convex part; 16 fourth convex part; 17 fifth convex part; 18 sixth convex part;
20 first coil; 30 second coil; 40 third coil; 50 fourth coil;
100 pulse transformer; 200 adhesive layer; 300 magnetic cover; 301 base plate; and 302 side plate.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments acquired by the ordinary technical staff in the art without creative effects belong to the scope of the present disclosure.

The present disclosure aims to provide a coil device and a pulse transformer to solve the technical problem that the existing coil device is prone to short-circuit and poor in welding stability.

To make the foregoing objectives, features and advantages of the present disclosure clearer and more comprehensible, the present disclosure is further described in detail below with reference to the accompanying drawings and specific embodiments.

### Embodiment I

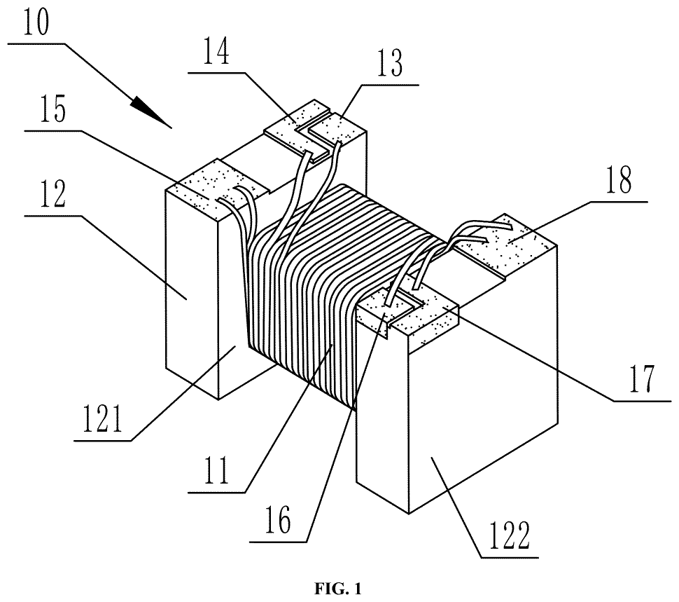

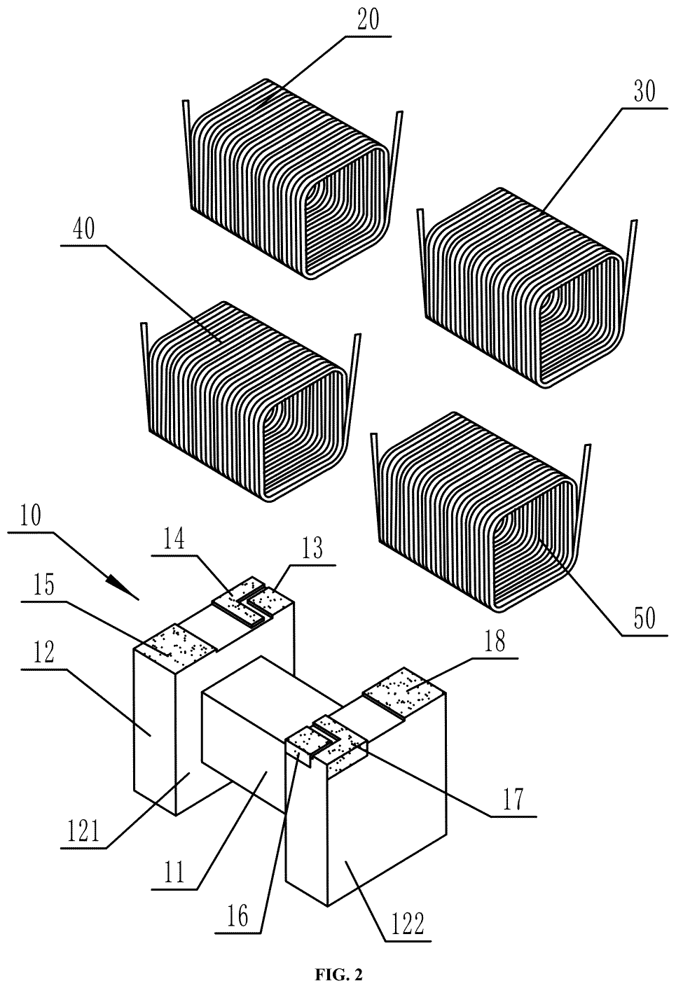

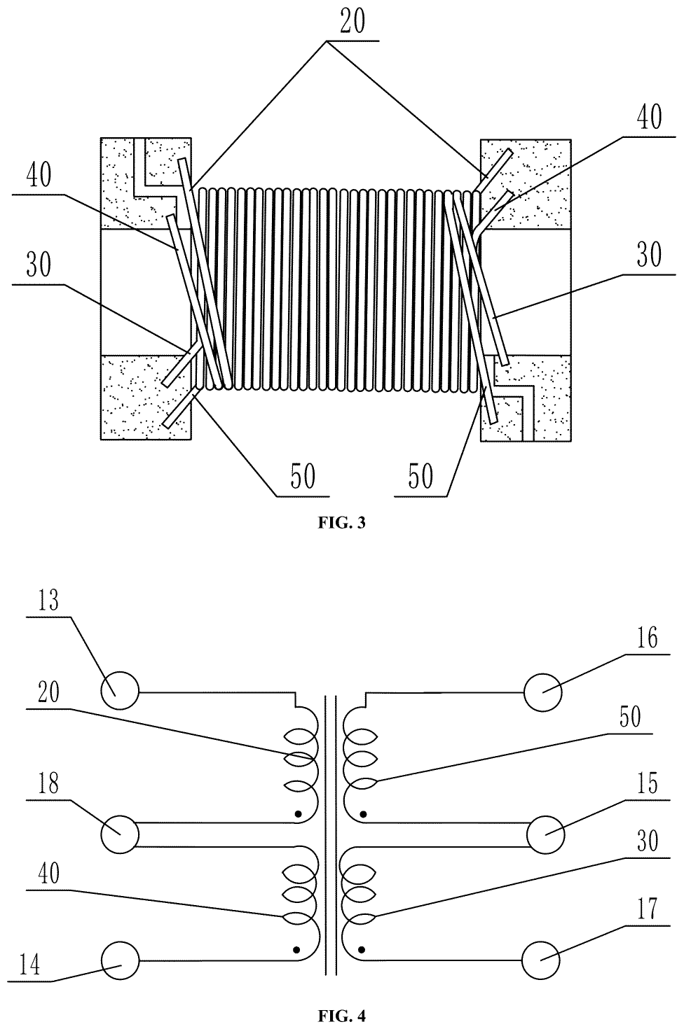

As shown in FIG. 1 to FIG. 4, the embodiment provides a coil device 10. The coil device 10 includes a core part and a plurality of coils. The core part includes one winding part 11 and two mounting parts 12. The two mounting parts 12 are respectively located on both ends of the winding part 11. Each of the coils is wound on the periphery of the winding part 11. An upper end of each mounting part 12 is provided with a plurality of convex parts arranged at intervals. Each of the convex parts is provided with an electroplated layer. Ends of each of the coils are connected with different electroplated layers. One side, connected to the winding part 11, of each mounting part 12 is an inner edge surface 121, and one side, opposite to the inner edge surface 121, of each mounting part 12 is an outer edge surface 122. There are no gaps between the electroplated layer and the inner edge surface 121 and between the electroplated layer and the outer edge surface 122, so that both sides of the electroplated layer are avoided from being non-uniform in weight distribution and further the coil device is avoided from falling off, improving the qualified rate of products.

Specifically, the convex parts on one of the two mounting parts 12 includes a first convex part 13, a second convex part 14 and a third convex part 15 which are arranged in sequence. The first convex part 13 and the third convex part 15 are respectively located at both ends of the one of the mounting parts 12. The convex parts on the other of the mounting parts 12 includes a fourth convex part 16, a fifth convex part 17 and a sixth convex part 18 which are arranged in sequence. The fourth convex part 16 and the sixth convex part 18 are respectively located at both ends of the other of the mounting parts 12. One side of the electroplated layer on each of the first convex part 13, the second convex part 14, the third convex part 15, the fourth convex part 16, the fifth convex part 17 and the sixth convex part 18 is connected with the inner edge surface 121. The other side of each of the electroplated layers on the third convex part 15 and the sixth convex part 18 is connected with an upper end of the outer edge surface 122. The other side of each of the electroplated layers on the second convex part 14 and the fifth convex part 17 extends to a surface of the outer edge surface 122. The other side of each of the electroplated layers on the first convex part 13 and the fourth convex part 16 extends to a side wall surface perpendicular to the inner edge surface 121 and the outer edge surface 122. As there is not a electroplated layer arranged on the inner edge surface 121, the end points of the coils can be prevented from being overlapped to a certain extent. Thus, when the coil device, the coils or the transformer is welded to the circuit board, the end points of the coils are not prone to be damaged by the extrusion friction of the circuit board, so that the problem of short circuit caused by the damage of the enameled insulating layer can be effectively avoided, and then the qualified rate of products can be improved. At the same time, as the electroplated layers on some of the convex parts extend to the surface of the outer edge surface 122 and the electroplated layers on some of the convex parts extend to a side wall between the outer edge surface 122 and the inner edge surface 121, when the coil device 10 in this embodiment needs to pass through the furnace, the coil device can be more firmly welded to the circuit board so as to improve the stability and avoid the coil device 10 from falling off from the circuit board.

The second convex part 14 and the fifth convex part 17 are both L-shaped. The first convex part 13, the third convex part 15, the fourth convex part 16 and the sixth convex part 18 are all rectangular. The first convex part 13 is located at a notch of the second convex part 14. The fourth convex part 16 is located at a notch of the fifth convex part 17, so that the area of the electroplated layer can be increased to a certain extent.

The plurality of coils include four coils including a first coil 20, a second coil 30, a third coil 40 and a fourth coil 50. A starting end of the first coil 20 is located on the electroplated layer on the first convex part 13, and a tail end of the first coil 20 is located on the electroplated layer on the sixth convex part 18. A starting end of the second coil 30 is located on the electroplated layer on the third convex part 15, and a tail end of the second coil 30 is located on the electroplated layer on the fifth convex part 17. A starting end of the third coil 40 is located on the electroplated layer on the sixth convex part 18, and a tail end of the third coil 40 is located on the electroplated layer on the second convex part 14. A starting end of the fourth coil 50 is located on the electroplated layer on the fourth convex part 16, and a tail end of the fourth coil 50 is located on the electroplated layer on the third convex part 15. The winding direction of the first coil 20 is identical with that of the second coil 30, the winding direction of the third coil 40 is identical with that of the fourth coil 50, and the winding direction of the first coil 20 is opposite to that of the third coil 40.

The convex parts, the mounting part 12 and the winding part 11 are made of same materials and integrally molded.

### Embodiment II

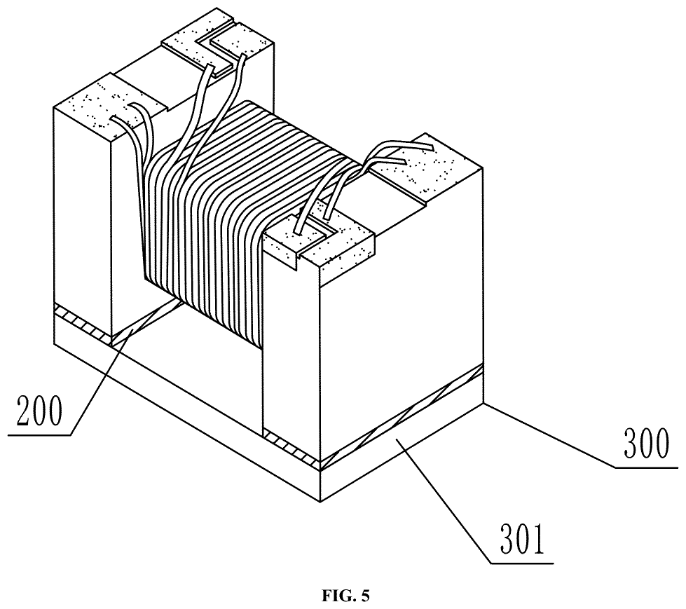

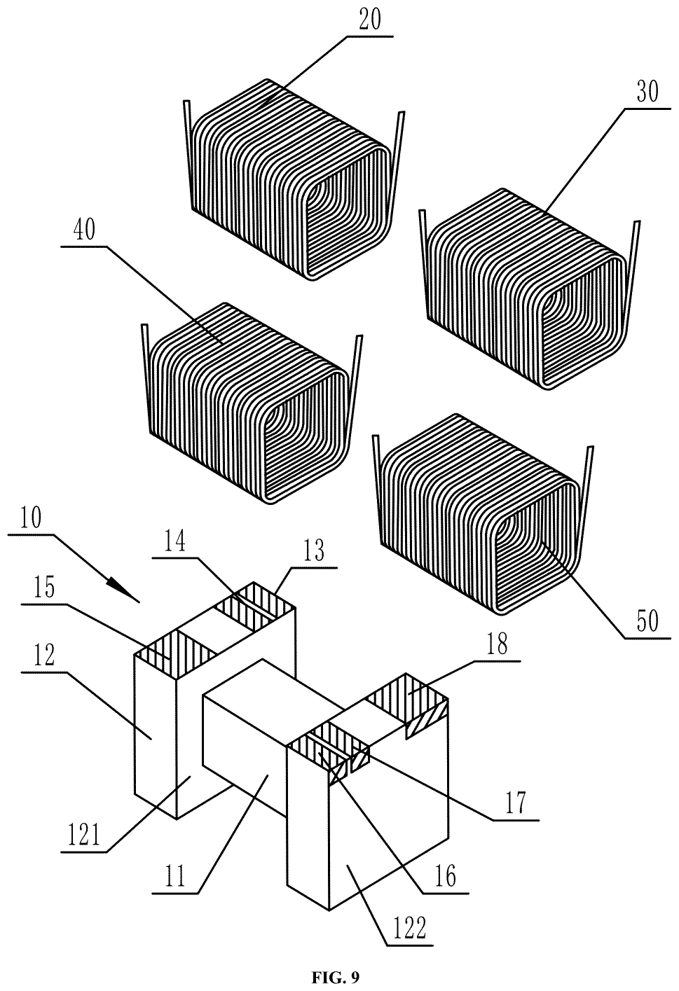

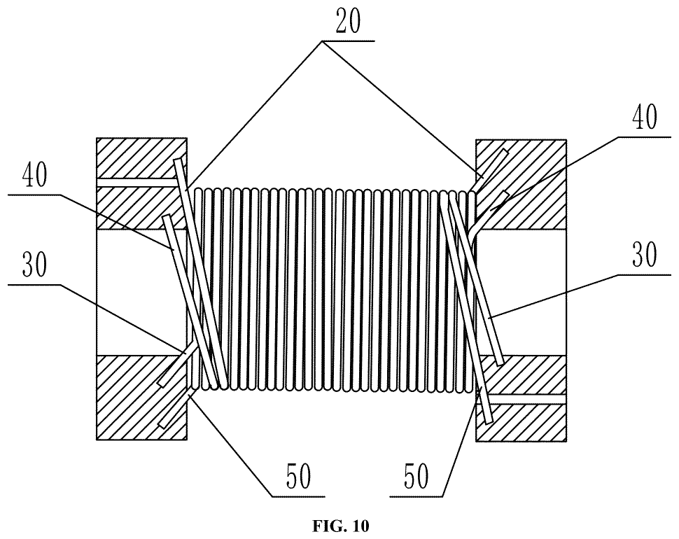

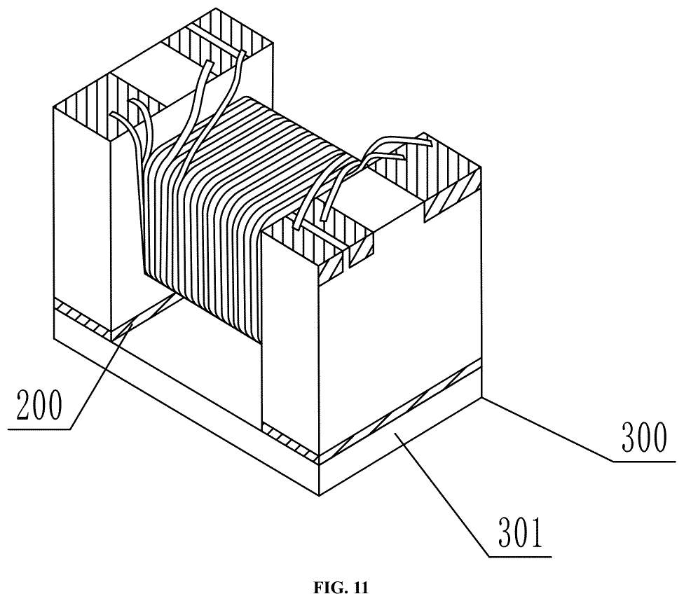

As shown in FIG. 4, and FIG. 8 to FIG. 13, the difference between Embodiment II and Embodiment I lies in that one side of the electroplated layer on each of the first convex part 13, the second convex part 14, the third convex part 15, the fourth convex part 16, the fifth convex part 17 and the sixth convex part 18 extends to the surface of the outer edge surface 122. As the electroplated layer on each convex part extends to the surface of the outer edge surface 122, the connection is stable. When the coil device 10 in this embodiment needs to pass through the furnace, the coil device can be more firmly welded to the circuit board so as to improve the stability and avoid the coil device 10 from falling off from the circuit board.

### Embodiment III

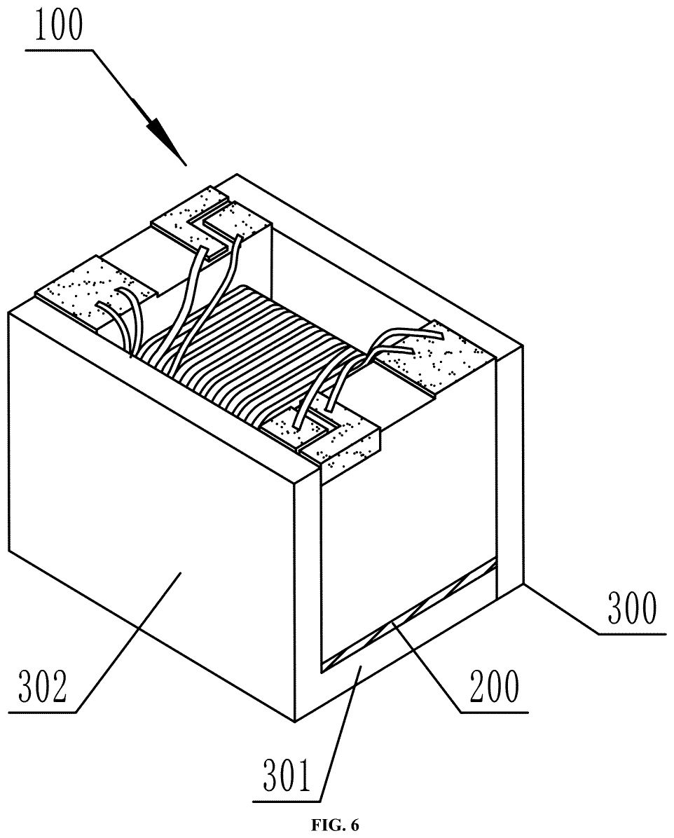

As shown FIG. 5, the embodiment provides a pulse transformer 100. The pulse transformer 100 includes a magnetic cover 300, an adhesive layer 200 and a coil device 10 in Embodiment I. The coil device 10 is mounted on the magnetic cover 300 via the adhesive layer 200.

The magnetic cover 300 includes a base plate 301. An upper end of the base plate 301 is connected with one end, away from the electroplated layer, of the mounting part 12 of the coil device 10 via the adhesive layer 200.

The adhesive layer 200 may include insulating magnetic powder glue consisting of resin and metallic magnetic powder.

The magnetic cover 300 may be made of manganese or zinc, but is not limited to manganese or zinc.

### Embodiment IV

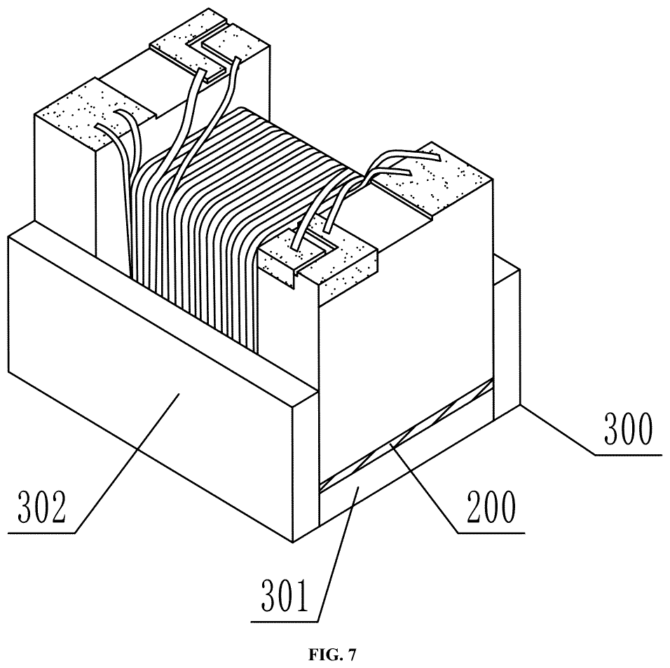

As shown in FIG. 6, the embodiment provides a pulse transformer 100. The difference between Embodiment IV and Embodiment III lies in that the magnetic cover 300 includes a base plate 301 and two side plates 302. The two side plates 302 are symmetrically mounted on both sides of the base plate 301. A connecting line between the two side plates 302 is perpendicular to a connecting line between the two mounting parts 12. An upper end of the side plate 302 is flush with an upper end of the mounting part 12, namely, the upper end of the side plate 302 is flush with one end, provided with the electroplated layer, of the mounting part 12.

### Embodiment V

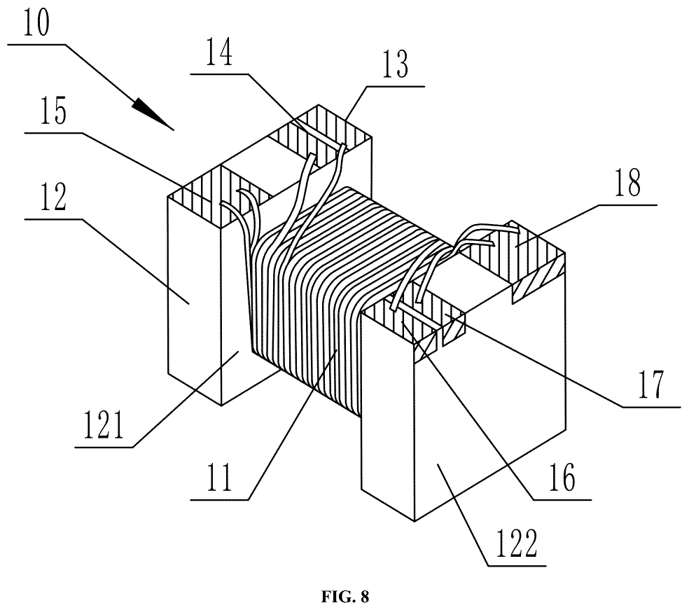

As shown in FIG. 7, the embodiment provides a pulse transformer 100. The difference between Embodiment V and Embodiment III lies in that a height of an upper end of the side plate 302 is equal to half of the height of an upper end of the mounting part 12.

### Embodiment VI

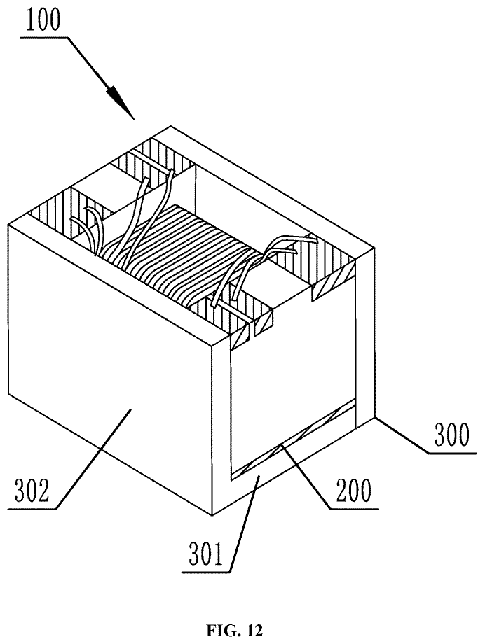

As shown in FIG. 11, the difference between Embodiment VI and embodiment III lies in that Embodiment VI includes the coil device 10 in Embodiment II.

### Embodiment VII

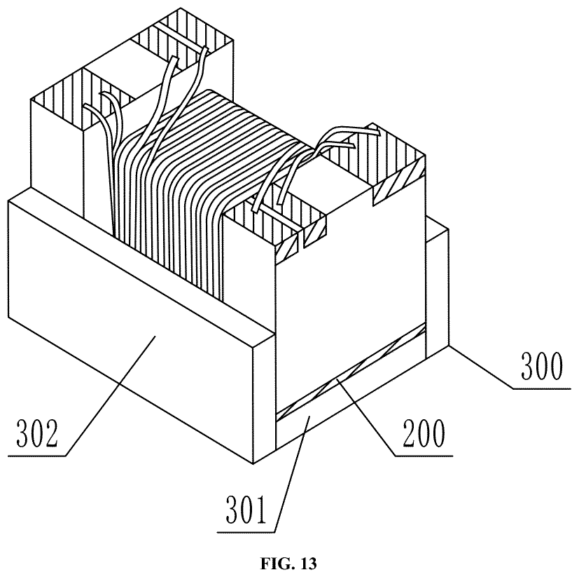

As shown in FIG. 12, the difference between Embodiment VII and Embodiment IV lies in that Embodiment VII includes a coil device 10 in Embodiment II.

### Embodiment VIII

As shown in FIG. 13, the difference between Embodiment VIII and Embodiment V lies in that Embodiment VIII includes a coil device 10 in Embodiment II.

Specific examples are used for illustration of the principles and implementation methods of the present disclosure. The description of the above-mentioned embodiments is used to help illustrate the method and the core principles of the present disclosure; and meanwhile, those skilled in the art can make various modifications in terms of specific embodiments and scope of application in accordance with the teachings of the present disclosure. In conclusion, the content of this specification shall not be construed as a limitation to the present disclosure.

What is claimed is:

1. A coil device, wherein the coil device comprises a core part and a plurality of coils, the core part comprises one winding part and two mounting parts, the two mounting parts are respectively located on both ends of the winding part, each of the coils is wound on a periphery of the winding part, an upper end of each of the two mounting part is provided with a plurality of convex parts arranged at intervals, each of the convex parts is provided with an electroplated layer, ends of each of the coils are connected with different electroplated layers, one side, connected to the winding part, of each of the two mounting parts is an inner edge surface, one side, opposite to the inner edge surface, of the each of the two mounting part is an outer edge surface, and there are no gaps between the electroplated layer and the inner edge surface and between the electroplated layer and the outer edge surface.

2. The coil device according to claim 1, wherein the convex parts on one of the two mounting parts comprise a first convex part, a second convex part and a third convex part which are arranged in sequence, and the convex parts on an other of the two mounting parts comprise a fourth convex part, a fifth convex part and a sixth convex part which are arranged in sequence, and one side of the electroplated layer on each of the first convex part, the second convex part, the third convex part, the fourth convex part, the fifth convex part and the sixth convex part is connected with an upper end of the inner edge surface.

3. The coil device according to claim 2, wherein an other side of the electroplated layer on each of the third convex part and the sixth convex part is connected with an upper end of the outer edge surface, an other side of the electroplated layer on each of the second convex part and the fifth convex part extends to a surface of the outer edge surface, and an other side of the electroplated layer on each of the first convex part and the fourth convex part extends to a side wall surface perpendicular to the inner edge surface and the outer edge surface.

4. The coil device according to claim 3, wherein the second convex part and the fifth convex part are both L-shaped, the first convex part, the third convex part, the fourth convex part and the sixth convex part are all rectangular, the first convex part is located at a notch of the second convex part, and the fourth convex part is located at a notch of the fifth convex part.

5. The coil device according to claim 2, wherein an other side of the electroplated layer on each of the first convex part, the second convex part, the third convex part, the fourth convex part, the fifth convex part and the sixth convex part extends to a surface of the outer edge surface.

6. The coil device according to claim 2, wherein the plurality of coils comprise four coils including a first coil, a second coil, a third coil and a fourth coil, a starting end of the first coil is located on the electroplated layer on the first convex part, and a tail end of the first coil is located on the electroplated layer on the sixth convex part; a starting end of the second coil is located on the electroplated layer on the third convex part, and a tail end of the second coil is located on the electroplated layer on the fifth convex part; a starting end of the third coil is located on the electroplated layer on the sixth convex part, and a tail end of the third coil is located on the electroplated layer on the second convex part; a starting end of the fourth coil is located on the electroplated layer on the fourth convex part, and a tail end of the fourth coil is located on the electroplated layer on the third convex part.

7. The coil device according to claim 1, wherein the convex parts, the two mounting parts and the winding part are made of same materials and integrally molded.

8. A pulse transformer, wherein the pulse transformer comprises a magnetic cover, an adhesive layer and the coil device according to claim 1, and the coil device is mounted on the magnetic cover via the adhesive layer.

9. The pulse transformer according to claim 8, wherein the magnetic cover comprises a base plate and two side plates, the two side plates are symmetrically mounted on both sides of the base plate, and a connecting line between the two side plates is perpendicular to a connecting line between the two mounting parts.

10. The pulse transformer according to claim 9, wherein an upper end of each of the two side plates is flush with an upper end of each of the two mounting parts, or a height of an upper end of each of the two side plates is equal to half of a height of an upper end of each of the two mounting parts.

11. The pulse transformer according to claim 8, wherein the convex parts on one of the two mounting parts comprise a first convex part, a second convex part and a third convex part which are arranged in sequence, and the convex parts on an other of the two mounting parts comprise a fourth convex part, a fifth convex part and a sixth convex part which are arranged in sequence, and one side of the electroplated layer on each of the first convex part, the second convex part, the third convex part, the fourth convex part, the fifth convex part and the sixth convex part is connected with an upper end of the inner edge surface.

12. The pulse transformer according to claim 11, wherein an other side of the electroplated layer on each of the third convex part and the sixth convex part is connected with an upper end of the outer edge surface, an other side of the electroplated layer on each of the second convex part and the fifth convex part extends to a surface of the outer edge surface, and an other side of the electroplated layer on each of the first convex part and the fourth convex part extends to a side wall surface perpendicular to the inner edge surface and the outer edge surface.

13. The pulse transformer according to claim 12, wherein the second convex part and the fifth convex part are both L-shaped, the first convex part, the third convex part, the fourth convex part and the sixth convex part are all rectangular, the first convex part is located at a notch of the second convex part, and the fourth convex part is located at a notch of the fifth convex part.

14. The pulse transformer according to claim 11, wherein an other side of the electroplated layer on each of the first convex part, the second convex part, the third convex part, the fourth convex part, the fifth convex part and the sixth convex part extends to a surface of the outer edge surface.

15. The pulse transformer according to claim 11, wherein the plurality of coils comprise four coils including a first coil, a second coil, a third coil and a fourth coil, a starting end of the first coil is located on the electroplated layer on the first convex part, and a tail end of the first coil is located on the electroplated layer on the sixth convex part; a starting end of the second coil is located on the electroplated layer on the third convex part, and a tail end of the second coil is located on the electroplated layer on the fifth convex part; a starting end of the third coil is located on the electroplated layer on the sixth convex part, and a tail end of the third coil is located on the electroplated layer on the second convex part; a starting end of the fourth coil is located on the electroplated layer on the fourth convex part, and a tail end of the fourth coil is located on the electroplated layer on the third convex part.

16. The pulse transformer according to claim 8, wherein the convex parts, the two mounting parts and the winding part are made of same materials and integrally molded.

17. The pulse transformer according to claim 11, wherein the magnetic cover comprises a base plate and two side plates, the two side plates are symmetrically mounted on both sides of the base plate, and a connecting line between the two side plates is perpendicular to a connecting line between the two mounting parts.

18. The pulse transformer according to claim 12, wherein the magnetic cover comprises a base plate and two side plates, the two side plates are symmetrically mounted on both sides of the base plate, and a connecting line between the two side plates is perpendicular to a connecting line between the two mounting parts.

19. The pulse transformer according to claim 13, wherein the magnetic cover comprises a base plate and two side plates, the two side plates are symmetrically mounted on both sides of the base plate, and a connecting line between the two side plates is perpendicular to a connecting line between the two mounting parts.

20. The pulse transformer according to claim 14, wherein the magnetic cover comprises a base plate and two side plates, the two side plates are symmetrically mounted on both sides of the base plate, and a connecting line between the two side plates is perpendicular to a connecting line between the two mounting parts.
